(19) United States
(12) Patent Application Publication
(10) Pub. No.: US 2023/0394414 A1
(43) Pub. Date: Dec. 7, 2023

(54) MOBILE APPLICATION FOR PROVIDING CENTRALIZED STORAGE OF EDUCATION AND EMPLOYMENT DATA

(71) Applicant: Fence Post, LLC, Sonoma, CA (US)

(72) Inventor: George Lawrence Bevan, III, Sonoma, CA (US)

(21) Appl. No.: 18/205,996

(22) Filed: Jun. 5, 2023

Related U.S. Application Data
(60) Provisional application No. 63/349,457, filed on Jun. 6, 2022.
(60) Provisional application No. 63/417,251, filed on Oct. 18, 2022.

(51) Int. Cl. G06Q 10/0639; G06Q 50/20

(52) U.S. Cl. CPC G06Q 10/0639; G06Q 50/20

(57) ABSTRACT

A mobile or desktop application and associated system that provides a centralized storage platform for users to motivate the users to capture, organize, and/or share the user's own achievements over time is described herein. As one example, the users may be students, and the centralized storage platform may motivate such users to capture, organize, and/or share the user's own achievements over time in preparation for college admissions or employment (e.g., trade-based employment, college graduate employment, etc.).

### CROSS-REFERENCE TO RELATED APPLICATIONS

This application claims the benefit of U.S. Provisional Patent Application No. 63/349,457, entitled “MOBILE APPLICATION FOR PROVIDING CENTRALIZED STORAGE OF EDUCATION AND EMPLOYMENT DATA” and filed on Jun. 6, 2022, and of U.S. Provisional Patent Application No. 63/417,251, entitled “MOBILE APPLICATION FOR PROVIDING CENTRALIZED STORAGE OF EDUCATION AND EMPLOYMENT DATA” and filed on Oct. 18, 2022, which are each hereby incorporated by reference herein in its entirety.

### BACKGROUND

The filing system in typical operating systems may allow users to organize stored files in one or more folders. For example, a user may store related files in the same folder (e.g., files of the same file type, files corresponding to the same project, files corresponding to the same person, place, or thing, etc.). A typical operating system may also allow users to share one or more folders with other computing devices that can access the shared folder(s) via a network. For example, the user can set permissions of an individual folder that allows the user to select which other users and/or computing devices may have access to the individual folder via a network.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system for centralizing storage of user data. The system comprises memory that stores computer-executable instructions. The system further comprises a processor in communication with the memory, where the computer-executable instructions, when executed by the processor, cause the processor to: obtain education data from a user device; apply the education data as an input to a goal derivation artificial intelligence model, where application of the education data as the input to the goal derivation artificial intelligence model causes the goal derivation artificial intelligence model to output a goal; apply the goal as an input to a goal booster artificial intelligence model, where application of the goal as the input to the goal booster artificial intelligence model causes the goal booster artificial intelligence model to output an indication of a suggested accomplishment to pursue to achieve the goal; and cause the user device to display the suggested accomplishment in a user interface in response to a user selection of a goal booster user interface element depicted in the user interface.

The system of the preceding paragraph can include any sub-combination of the following features: where the computer-executable instructions, when executed, further cause the processor to apply the goal and the education data as the input to the goal booster artificial intelligence model; where the computer-executable instructions, when executed, further cause the processor to train the goal derivation artificial intelligence model using training data, where the training data comprises one or more training data items, and where an individual training data item comprises a set of accomplishments recorded by a second user and is labeled with an indication of a second goal pursued by the second user; where the computer-executable instructions, when executed, further cause the processor to train the goal booster artificial intelligence model using training data, where the training data comprises one or more training data items, and where an individual training data item comprises a set of accomplishments recorded by a second user and is labeled with an indication of whether a second goal pursued by the second user was achieved by the second user; where the goal derivation artificial intelligence model comprises one of a machine learning model or a neural network; where the user interface comprises a second user interface element that allows a user of the user device to capture the education data; where the user interface comprises a library of stored second education data organized by category; where the user interface comprises an indication of a progress of a user in achieving the goal; and where the education data comprises at least one of an image of an academic award won or academic achievement earned by a user, an image of a trophies earned by the user, data representing an athletic performance or achievement by the user, a report card received by the user, a transcript received by the user, a test score earned by the user, a writing sample written by the user, an image of artwork created by the user, a resume, video of a performance by the user, or audio of a second performance by the user.

Another aspect of the disclosure provides a computer-implemented method for centralizing storage of user data. The computer-implemented method comprises: obtaining the user data from a user device; applying the user data as an input to a goal derivation artificial intelligence model, where application of the user data as the input to the goal derivation artificial intelligence model causes the goal derivation artificial intelligence model to output a goal; applying the goal as an input to a goal booster artificial intelligence model, where application of the goal as the input to the goal booster artificial intelligence model causes the goal booster artificial intelligence model to output an indication of a suggested accomplishment to pursue to achieve the goal; and causing the user device to display the suggested accomplishment in a user interface in response to a user selection of a goal booster user interface element depicted in the user interface.

The computer-implemented method of the preceding paragraph can include any sub-combination of the following features: where applying the goal as the input to the goal booster artificial intelligence model further comprises applying the goal and the user data as the input to the goal booster artificial intelligence model; where the computer-implemented method further comprises training the goal derivation artificial intelligence model using training data, where the training data comprises one or more training data items, and where an individual training data item comprises a set of accomplishments recorded by a second user and is labeled with an indication of a second goal pursued by the second user; where the computer-implemented method further comprises training the goal booster artificial intelligence model using training data, where the training data comprises one or more training data items, and where an individual training data item comprises a set of accomplishments recorded by a second user and is labeled with an indication of whether a second goal pursued by the second user was achieved by the second user; where the goal derivation artificial intelligence model comprises one of a machine learning model or a neural network; where the user interface comprises a second user interface element that allows a user of the user device to capture the education data; where the user interface comprises a library of stored second education data organized by category; where the user interface comprises an indication of a progress of a user in achieving the goal; and where the user data comprises at least one of an image of an academic award won or academic achievement earned by a user, an image of a trophies earned by the user, data representing an athletic performance or achievement by the user, a report card received by the user, a transcript received by the user, a test score earned by the user, a writing sample written by the user, an image of artwork created by the user, a resume, video of a performance by the user, audio of a second performance by the user, an indication of a degree earned by the user, or proof of a skill learned by the user.

Another aspect of the disclosure provides a non-transitory, computer-readable medium comprising computer-executable instructions for retrieving property information, where the computer-executable instructions, when executed by a computer system, cause the computer system to: obtain the user data from a user device; apply the user data as an input to a goal derivation artificial intelligence model, where application of the user data as the input to the goal derivation artificial intelligence model causes the goal derivation artificial intelligence model to output a goal; apply the goal as an input to a goal booster artificial intelligence model, where application of the goal as the input to the goal booster artificial intelligence model causes the goal booster artificial intelligence model to output an indication of a suggested accomplishment to pursue to achieve the goal; and cause the user device to display the suggested accomplishment in a user interface in response to a user selection of a goal booster user interface element depicted in the user interface.

The non-transitory, computer-readable medium of the preceding paragraph can include any sub-combination of the following features: where the computer-executable instructions, when executed, further cause the computer system to train the goal derivation artificial intelligence model using training data, where the training data comprises one or more training data items, and where an individual training data item comprises a set of accomplishments recorded by a second user and is labeled with an indication of a second goal pursued by the second user.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which an achievement aggregation system provides access to a centralized storage platform that allows users to capture, organize, and/or share the user's own achievements over time.

FIG. 2 is a flow diagram illustrating the operations performed by the components of the operating environment of FIG. 1 to share education and/or employment data.

FIG. 3 is a flow diagram illustrating the operations performed by the components of the operating environment of FIG. 1 to provide a recommendation.

FIGS. 4A-4B illustrate example user interfaces of the mobile application that may be displayed to a user that has created an account and selected one or more goals.

FIG. 5 illustrates an example user interface of the mobile application showing a goal tab in a user's dashboard.

FIGS. 6A-6B illustrate example user interfaces of the mobile application showing a to do list tab and a success tab in a user's dashboard.

FIGS. 7A-7C illustrate example user interfaces of the mobile application showing a user library.

FIGS. 8A-8B illustrate another example user interfaces of the mobile application showing a user library.

FIGS. 9A-9D illustrate example user interfaces of the mobile application showing a user profile.

FIG. 10 illustrates an example user interface of a landing page of a desktop application.

FIG. 11 illustrates an example user interface of a setup page of a desktop application.

FIG. 12 illustrates an example user interface of a dashboard page of a desktop application.

FIG. 13 illustrates an example user interface of a goal booster page of a desktop application that may be presented to the user when the user selects the goal booster button.

FIG. 14 illustrates an example user interface of an invitation page of a desktop application.

FIG. 15 illustrates an example user interface of a profile page of a desktop application.

FIG. 16 illustrates an example user interface of a library page of a desktop application.

FIG. 17 illustrates an example user interface of a community page of a desktop application.

FIGS. 18-19 illustrates an example user interface of a video introduction page of a desktop application.

FIG. 20 illustrates an example user interface of an accomplishment add page of a desktop application that allows a user to record and store an accomplishment.

FIG. 21 is a flow diagram depicting an example, centralized storage routine illustratively implemented by an achievement aggregation system, according to one embodiment.

### DETAILED DESCRIPTION

As described above, the filing system in typical operating systems may allow users to organize stored files in one or more folders and/or to share access to the folder(s) with one or more other users and/or computing devices. Often, however, the files stored in a shared folder local to a user's computing device may only be accessible if the user's computing device is powered on and connected to a network. The user's computing device may also have memory limitations that could prevent large files from being stored in a shared folder.

As a result, network-accessible file storage systems exist that allow users to create an account and store files on a server or a set of server computing devices. For example, a user can create an account with a service running on the server or set of server computing devices, create a folder associated with the account, and upload a file to the server(s) for storage in the created folder. The user may then have the option of sharing the folder with another user or computing device. Once shared, the user or computing device that is granted access to the folder may access the folder by communicating with the server or set of server computing devices. The server or set of server computing devices may have more memory capacity than the user's computing device and may be generally accessible 24 hours a day, and therefore the user or computing device with which the folder is shared may have access to the shared folder regardless of the memory capabilities or power status of the user's computing device.

Storing files in a folder in a typical network-accessible file storage system may have several technical deficiencies, however. For example, the files that are available in the shared folder of the typical network-accessible file storage system may be those files that the user has uploaded to the network-accessible file storage system. The user or computing device with which the folder of the typical network-accessible file storage system is shared may desire access to a certain file. If that file is not uploaded by the user to the folder (e.g., because the user forgot to upload the file, the user's computing device is incapable of transmitting the file, a network disruption prevents upload of the file, etc.), then the other user or computing device may not be able to gain access to the file even though the other user or computing device has access to the shared folder.

In addition, typical network-accessible file storage systems that provide shared access to folders lack certain file processing capabilities. For example, a user may desire to track goals, accomplishments, tasks, or other actions associated with the uploaded files and/or that may be unique to the user himself or herself. The tracking could, for example, lead to automatic notifications being sent to a user or computing device with which a folder is shared, reminders being sent to the user that has shared the folder, the reorganization of files stored in a shared folder (e.g., the automatic creation of sub-folders, automatic movement of a file from one folder to another folder, etc.), an action being taken to meet a time deadline, and/or the like. Typical network-accessible file storage systems, however, do not provide such specific features or capabilities.

Accordingly, the present disclosure generally relates to a mobile application and associated system that provides a centralized storage platform for users to motivate the users to capture, organize, and/or share the user's own achievements over time. As one example, the users may be students aged 5-22, and the centralized storage platform may motivate such users to capture, organize, and/or share the user's own achievements over time in preparation for college admissions or employment (e.g., trade-based employment, college graduate employment, etc.).

The mobile application may run on a user device, such as a desktop computer, laptop, and a mobile phone. In general, the user device can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. A user device may execute the mobile application or a third-party application (e.g., a browser) that can access the functionality of the mobile application described herein via a network page (e.g., a web page).

The mobile application, via the user device, can communicate with a computing system (e.g., a server) over a network to store and/or access education and/or employment data captured or obtained by a user via the mobile application. The network may include any wired network, wireless network, or combination thereof. For example, the network may be a personal area network, local area network, wide area network, over-the-air broadcast network (e.g., for radio or television), cable network, satellite network, cellular telephone network, or combination thereof. As a further example, the network may be a publicly accessible network of linked networks, possibly operated by various distinct parties, such as the Internet. In some embodiments, the network may be a private or semi-private network, such as a corporate or university intranet. The network may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The computing system may be a single computing device, or it may include multiple distinct computing devices, such as computer servers, logically or physically grouped together to collectively operate as a server system. The components of the computing system can each be implemented in application-specific hardware (e.g., a server computing device with one or more ASICs) such that no software is necessary, or as a combination of hardware and software. In addition, the modules and components of the computing system can be combined on one server computing device or separated individually or into groups on several server computing devices.

In some embodiments, the features and services provided by the computing system may be implemented as web services consumable via the network. In further embodiments, the computing system is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

Any number of user devices may communicate with the computing system at any given time. Thus, different users each using the mobile application on their respective user devices can store and/or access education and/or employment data simultaneously, concurrently, and/or overlapping in time.

The computing system may also communicate with school administrator devices and/or employer devices via the network. A school administrator device may be similar to a user device, but operated by an administrator or admissions officer at an educational institution. Similarly, an employer device may be similar to a user device, but operated by a hiring manager or company employee in charge of hiring at a place of employment. A school administrator device and/or an employer device can also run a mobile application that allows the respective user to retrieve education and/or employment data captured or obtained by a user (e.g., a student) using the user device. Each user (e.g., student) of a user device may have a separate account with the centralized storage platform (e.g., each user may have a login and password used to access the user's account and education and/or employment data, and a user of a school administrator device and/or an employer device can access different user accounts that have granted access to the school or place of employment). A user can also grant access to his or her account to a mentor, a recommender, a teacher, a coach, etc.

Education data can include any electronic data that may be useful to a school in deciding whether to admit a potential student. For example, education data can include images of academic awards won or academic achievements earned by a user, images of trophies earned by a user, data representing an athletic performance or achievement by a user, report cards received by a user, transcripts received by a user, test scores earned by a user, writing samples (e.g., essays, book reports, etc.) written by a user, images of artwork created by a user, a resume, video and/or audio of a performance by the user (e.g., dance recital, music recital, a play, etc.), and/or other recognitions earned by a user. Employment data can include images of academic awards won or academic achievements earned by a user, images of trophies earned by a user, data representing an athletic performance or achievement by a user, report cards received by a user, transcripts received by a user, test scores earned by a user, writing samples (e.g., essays, book reports, etc.) written by a user, images of artwork created by a user, a resume, video and/or audio of a performance by the user (e.g., dance recital, music recital, a play, etc.), an indication of a degree earned by a user, proof of a skill learned by a user, and/or other recognitions earned by a user. Any of the data described herein that may comprise the education data and/or the employment data can be in the form of a text file, a database file, an image file, a video file, an audio file, and/or any other digital media file.

The foregoing aspects and many of the attendant advantages of this disclosure will become more readily appreciated as the same become better understood by reference to the following detailed description, when taken in conjunction with the accompanying drawings.

### Example Centralized Storage Platform Environment

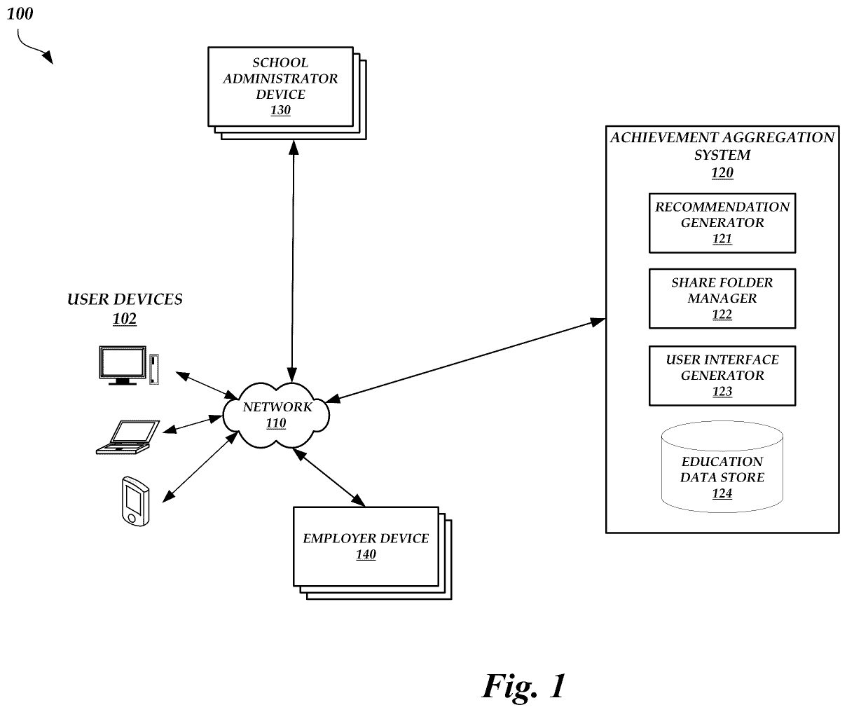

FIG. 1 is a block diagram of an illustrative operating environment 100 in which an achievement aggregation system 120 provides access to a centralized storage platform that allows users to capture, organize, and/or share the user's own achievements over time. The operating environment 100 further includes one or more school administrator devices 130, one or more employer devices 140, and one or more user devices 102 that may communicate with the achievement aggregation system 120 via network 110.

Various example user devices 102 are shown in FIG. 1, including a desktop computer, laptop, and a mobile phone, each provided by way of illustration. In general, the user devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. A user device 102 may execute a mobile application or a third-party application (e.g., a browser) that can access the functionality of the mobile application described herein via a network page (e.g., a content page, a web page, etc.).

The achievement aggregation system 120 can be a computing system configured to generate unique identifiers for individual blocks, parcels, and/or structures, to link property data records, and/or to categorize individual structures of a parcel into one or more hazard zones. The achievement aggregation system 120 may be a single computing device, or it may include multiple distinct computing devices, such as computer servers, logically or physically grouped together to collectively operate as a server system. The components of the achievement aggregation system 120 can each be implemented in application-specific hardware (e.g., a server computing device with one or more ASICs) such that no software is necessary, or as a combination of hardware and software. In addition, the modules and components of the achievement aggregation system 120 can be combined on one server computing device or separated individually or into groups on several server computing devices. In some embodiments, the achievement aggregation system 120 may include additional or fewer components than illustrated in FIG. 1.

In some embodiments, the features and services provided by the achievement aggregation system 120 may be implemented as web services consumable via the communication network 110. In further embodiments, the achievement aggregation system 120 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

The achievement aggregation system 120 may include various modules, components, data stores, and/or the like to provide the unique identifier generation, linking, and hazard zone categorization functionality described herein. For example, the achievement aggregation system 120 may include a recommendation generator 121, a share folder manager 122, a user interface generator 123, and an education data store 124.

The recommendation generator 121 may be configured to process education and/or employment data associated with a user to generate prompts, recommendations, and/or reminders that can be presented to the user via a user interface (e.g., a mobile or desktop application running on a user device 102). For example, the mobile or desktop application running on the user device 102 can communicate with the achievement aggregation system 120 over the network 110 and upload education and/or employment data captured or obtained by a user via the mobile application for storage (e.g., in the education data store 124) and/or access previously-uploaded education and/or employment data. Any number of user devices 102 may communicate with the achievement aggregation system 120 at any given time. Thus, different users each using the mobile or desktop application running on their respective user devices 102 can upload and/or access education and/or employment data simultaneously, concurrently, and/or overlapping in time.

The mobile or desktop application running on a user device 102 includes a capture feature, an organize feature, and a share feature that are accessible and with which a user can interact via a user interface rendered and displayed by the user device 102. With the capture feature, a user can use the mobile or desktop application to see, in a dashboard, at-a-glance updates on a home screen based on where the user is in his or her journey and where the user wants to go. For example, the dashboard may include custom reminders, badges, and/or prompts regarding captured or to-be-captured education and/or employment data. The recommendation generator 121 can generate the custom reminders, badges, and/or prompts for a user based on the education and/or employment data uploaded by the user. As an illustrative example, the recommendation generator 121 can train, using training data, one or more artificial intelligence models (e.g., machine learning models, neural networks, etc.) to output a reminder, badge, and/or prompt to display to a user given the education and/or employment data captured by the user. The training data can include education and/or employment data associated with one or more users, where the data associated with a particular user is labeled with an indication of a reminder, badge, or prompt that was provided to the particular user and/or is labeled with an indication that no reminder, badge, or prompt was provided to the particular user. Once trained, the recommendation generator 121 can apply some or all of the education and/or employment data captured by a user as an input to the trained artificial intelligence model, which causes the trained artificial intelligence model to output an indication of a reminder, badge, and/or prompt to display to the user, if any (e.g., the output can be an indication that no reminder, badge, and/or prompt is to be displayed to the user).

Optionally, the recommendation generator 121 may perform pre-processing of some or all of the education and/or employment data prior to providing the data as an input to the trained artificial intelligence model. For example, if the education and/or employment data includes an image or video file, the recommendation generator 121 can perform image processing on the image file or a frame of the video file to determine an object or item present in the image or frame. In particular, the image processing can include performing edge detection on pixels in the image or frame to detect objects or items present in the image or frame. The training data can then include an identification of the object or item detected in the image or frame. Similarly, if the education and/or employment data includes an audio file or video file, the recommendation generator 121 can perform speech recognition on the audio in the audio file or video file to generate a transcript. The training data can then include the transcript. If the education and/or employment data includes a text file, an audio file, an image file, and/or a video file, the recommendation generator 121 can extract text from the file and include the text in the training data. Thus, the recommendation generator 121 can perform pre-processing of some or all of the education and/or employment data to generate data that can be included in the training data for use in training the artificial intelligence model(s).

The user can also use the mobile or desktop application to, in a library, capture, organize, and/or archive achievements (e.g., education and/or employment data) over time. The user may create a custom roadmap via the mobile application (e.g., with the organize feature) that allows the user to set custom goals, and the library may include badges for completing different parts of the roadmap. The recommendation generator 121 can receive the custom goals set by the user and generate prompts or reminders based on a timeline or deadline associated with the custom goals. For example, if a goal is to complete a task or achievement by a certain date, the recommendation generator 121 may cause the mobile or desktop application to pop-up a prompt or reminder about the goal near or on the date. The library also allows a user to create folders and/or binders to share education and/or employment data with mentors, recommenders, schools, places of employment, etc.

With the organize feature, a user can use the mobile application to customize a timeline and/or select template(s) to help a user define his or her unique path to success. The organize feature may include a list of goals with prompts to help a user define the journey for himself or herself over time. The organize feature may also include a to do list that allows a user to set up, define, and/or explore topics to round out the career journey. For example, the recommendation generator 121 can obtain (e.g., from a third party data store, from a search engine, etc.) one or more topics for display in the mobile or desktop application based on the to do list set up by the user, the goals set by the user, and/or any other information related to the unique path to success defined by the user (e.g., if the recommendation generator 121 uses a search engine to obtain the topics, the recommendation generator 121 may generate a search query based on information related to the path to success defined by the user that the recommendation generator 121 provides to the search engine to obtain the topics). The topics can include local recommendations, ideas for activities, extracurricular activities, teams, communities to join, project ideas to start, and/or the like. The mobile or desktop application may include one or more preset areas or topics, but a user can add custom areas or topics as well.

With the share feature, a user can view a profile section that includes prompts to record timely accomplishments each time period (e.g., week, month, semester, etc.). The prompts can create a visual story/about me profile page that can become a shareable cover page (e.g., shareable to a mentor, a recommender, a teacher, a coach, a school, a place of employment, etc.).

The share folder manager 122 can manage access to the profile section and/or profile page for one or more users. For example, the share folder manager 122 can set permissions on data associated with a profile section and/or profile page in accordance with settings applied by a user that restrict or grant access to the profile section and/or profile page to certain user accounts and/or certain user devices 102. The share folder manager 122 can also manage access to other data associated with a user's account, such as some or all of the education and/or employment data uploaded by a user. Thus, the share folder manager 122 can restrict or grant access to some or all of the education and/or employment data uploaded by a particular user to certain user accounts and/or certain user devices 102. For example, the share folder manager 122 can grant a school administrator device 130 (e.g., operated by a school employee, such as an admissions officer) or an employer device 140 (e.g., operated by an employer) access to or restrict a school administrator device 130 or an employer device 140 from accessing a profile section, a profile page, and/or education and/or employment data.

Once a user creates an account, a user can capture or otherwise input accomplishments (e.g., education and/or employment data) corresponding to a particular career choice, goal, or specific timeline within the dashboard. The user device 102 can upload the inputted accomplishments to the achievement aggregation system 120 via the network 110, and the achievement aggregation system 120 can store the inputted accomplishments in the education data store 124. The library (e.g., the achievement aggregation system 120) may organize the inputted accomplishments into folders, binders, volumes, etc. that can be searched by a user or a person with which the account is shared by subject, data, accomplishment type, geography, name, etc. For example, a user can create a shareable folder within the library to send to potential community members (e.g., teachers, mentors, recommenders, coaches, schools, places of employments, etc. who may operate a school administrator device 130 or an employer device 140). Sharing a folder may include the user device 102 or share folder manager 122 transmitting a link that is accessible by the community member via another user device (e.g., a school administrator device 130, an employer device 140, etc.). Selection of the link may cause the community member's user device (e.g., a school administrator device 130, an employer device 140, etc.) to visualize education and/or employment data that the user stored in the shareable folder. The community member may be able to access any of the education and/or employment data stored therein to view additional information, to play a media file, etc.

The user interface generator 123 can generate user interface data that, when rendered by a user device 102, causes the user device 102 to display a user interface depicting one or more features of the mobile or desktop application described herein. For example, the user interface generator 123 can generate and transmit the user interface data to a user device 102, which causes the user device 102 to process the user interface data and render and display the user interface. In response to a user action (e.g., the user making a selection in the user interface, the user capturing education and/or employment data, and/or any other user interaction with the user interface) or an instruction received from the recommendation generator 121 or the share folder manager 122, the user interface generator 123 can generate updated user interface data and transmit the updated user interface data. Reception of the updated user interface data may cause the user device 102 to process the updated user interface data and render and display an updated version of the user interface that reflects the user action or the instruction received from the recommendation generator 121 or the share folder manager 122.

The education data store 124 can store education and/or employment data. Education data can include any electronic data that may be useful to a school in deciding whether to admit a potential student. For example, education data can include images of academic awards won or academic achievements earned by a user, images of trophies earned by a user, data representing an athletic performance or achievement by a user, report cards received by a user, transcripts received by a user, test scores earned by a user, writing samples (e.g., essays, book reports, etc.) written by a user, images of artwork created by a user, a resume, video and/or audio of a performance by the user (e.g., dance recital, music recital, a play, etc.), and/or other recognitions earned by a user. Employment data can include images of academic awards won or academic achievements earned by a user, images of trophies earned by a user, data representing an athletic performance or achievement by a user, report cards received by a user, transcripts received by a user, test scores earned by a user, writing samples (e.g., essays, book reports, etc.) written by a user, images of artwork created by a user, a resume, video and/or audio of a performance by the user (e.g., dance recital, music recital, a play, etc.), an indication of a degree earned by a user, proof of a skill learned by a user, and/or other recognitions earned by a user. Any of the data described herein that may comprise the education data and/or the employment data can be in the form of a text file, a database file, an image file, a video file, an audio file, and/or any other digital media file.

While the education data store 124 is depicted as being internal to the achievement aggregation system 120, this is not meant to be limiting. For example, the education data store 124 may be external to and in communication with the achievement aggregation system 120.

A school administrator device 130 may be similar to a user device 102, but operated by an administrator or admissions officer at an educational institution. Similarly, an employer device 140 may be similar to a user device 102, but operated by a hiring manager or company employee in charge of hiring at a place of employment. A school administrator device 130 and/or an employer device 140 can also run a mobile or desktop application that allows the respective user to retrieve education and/or employment data captured or obtained by a user (e.g., a student) using the user device 102. Each user (e.g., student) of a user device 102 may have a separate account with the achievement aggregation system 120 (e.g., each user may have a login and password used to access the user's account and education and/or employment data, and a user of a school administrator device 130 and/or an employer device 140 can access different user accounts that have granted access to the school or place of employment). A user can also grant access to his or her account to a mentor, a recommender, a teacher, a coach, etc. As described herein, the share folder manager 122 may manage folder permissions set by the user.

Example Block Diagram for Sharing Education and/or Employment Data

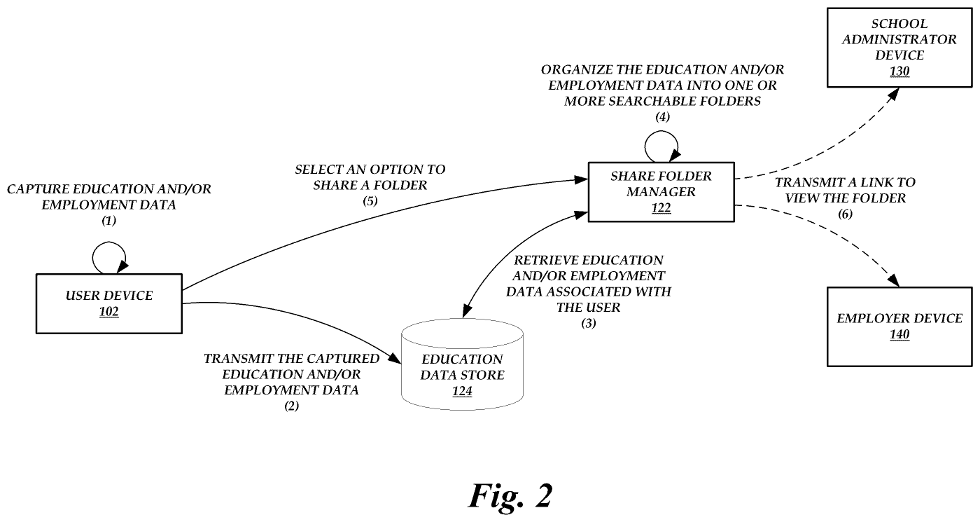

FIG. 2 is a flow diagram illustrating the operations performed by the components of the operating environment 100 of FIG. 1 to share education and/or employment data. As illustrated in FIG. 2, a user device 102 can capture education and/or employment data at (1). For example, a user may take a photo or video of an achievement using the user device 102, can download a media file corresponding to the achievement using the user device 102, and/or the like. The user device 102 can then transmit the captured education and/or employment data to the education data store 124 at (2) for storage in the achievement aggregation system 120. The user device 102 may repeat operations (1) and/or (2) periodically, such as when new achievements are accomplished, in response to prompts by the mobile or desktop application to meet timelines or satisfy goals, and/or the like. Optionally, the user device 102 can capture education and/or employment data in batches over a period of time and transmit the captured education and/or employment data periodically in bulk, asynchronously with the capture of the education and/or employment data. The user device 102 can store the education and/or employment data locally in memory to facilitate bulk transfer of the data and/or in situations in which the user device 102 lacks network access.

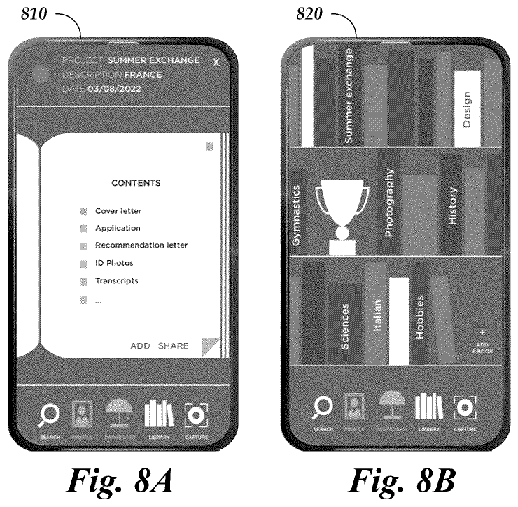

The share folder manager 122 can retrieve education and/or employment data associated with the user from the education data store 124 at (3). The share folder manager 122 can retrieve the data asynchronous from the data being stored in the education data store 124. The share folder manager 122 can organize the education and/or employment data into one or more searchable folders at (4). For example, the share folder manager 122 can parse the education and/or employment data, identify files that are related (e.g., related files may be files having the same file type, files corresponding to the same activity or achievement, files corresponding to a particular time range, etc.), and group files that are related into individual folders. Organization of the files may be represented by various folders or categories of a library visible in the user interface (see, e.g., FIGS. 8A-8B). The folder(s) may be considered searchable because a user may be able to enter a search query via the user interface to identify files stored therein.

Optionally, the user via the user device 102 can select an option to share a folder at (5). In making the selection, the user may identify the user, user account, user device 102, school, employer, etc. with which to grant (or restrict) access to the folder. If the user identifies a school, the share folder manager 122 can transmit a link to view the folder at (6) to a school administrator device 130 associated with the school. If the user identifies an employer, the share folder manager 122 can transmit a link to view the folder at (6) to an employer device 140 associated with the employer. If the user identifies another user device 102, the share folder manager 122 can transmit a link to view the folder to the other user device 102, and so on.

### Example Block Diagram for Providing a Recommendation

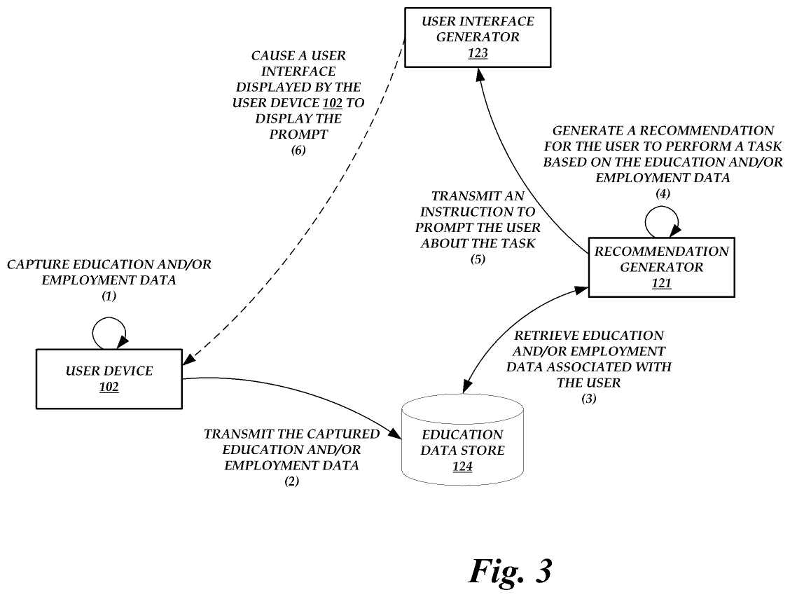

FIG. 3 is a flow diagram illustrating the operations performed by the components of the operating environment 100 of FIG. 1 to provide a recommendation. As illustrated in FIG. 3, a user device 102 can capture education and/or employment data at (1). For example, a user may take a photo or video of an achievement using the user device 102, can download a media file corresponding to the achievement using the user device 102, and/or the like. The user device 102 can then transmit the captured education and/or employment data to the education data store 124 at (2) for storage in the achievement aggregation system 120. The user device 102 may repeat operations (1) and/or (2) periodically, such as when new achievements are accomplished, in response to prompts by the mobile or desktop application to meet timelines or satisfy goals, and/or the like. Optionally, the user device 102 can capture education and/or employment data in batches over a period of time and transmit the captured education and/or employment data periodically in bulk, asynchronously with the capture of the education and/or employment data. The user device 102 can store the education and/or employment data locally in memory to facilitate bulk transfer of the data and/or in situations in which the user device 102 lacks network access.

The recommendation generator 121 can retrieve education and/or employment data associated with the user at (3). The recommendation generator 121 can retrieve the data asynchronous from the data being stored in the education data store 124. The recommendation generator 121 can generate a recommendation for the user to perform a task based on the education and/or employment data at (4). For example, the recommendation generator 121 can train an artificial intelligence model to predict a recommendation, and can apply some or all of the education and/or employment data as an input to the trained artificial intelligence model, which causes the trained artificial intelligence model to output a recommendation or prompt to display to a user.

The recommendation generator 121 can generate the recommendation prior to the recommendation being presented to the user in the user interface. For example, the output of the trained artificial intelligence model may be a recommendation to display a prompt to a user at a specified date and/or time (e.g., a date and/or time that coincides with the deadline for a goal to be accomplished, such as a date and/or time that is a week or two weeks prior to the deadline). The recommendation generator 121 can then cause the user interface to display the recommendation at the specified date and/or time. The recommendation generator 121 can then transmit an instruction to the user interface generator 123 to prompt the user about the task, goal, accomplishment, etc. at (5). For example, the recommendation generator 121 can transmit the instructions on or near the specified date and/or time.

The user interface generator 123 can optionally cause a user interface displayed by the user device 102 to display the prompt at (6). For example, the user interface generator 123 can generate updated user interface data that causes display of a user interface with the prompt and transmit the updated user interface data to the user device 102. The user device 102 can then process the updated user interface data to display the user interface with the prompt. Alternatively, the user interface generator 123 can cause an electronic message, text message, and/or the like that includes text and/or media corresponding to the prompt to be transmitted to an electronic mail server, another user device 102 of the user, and/or the like.

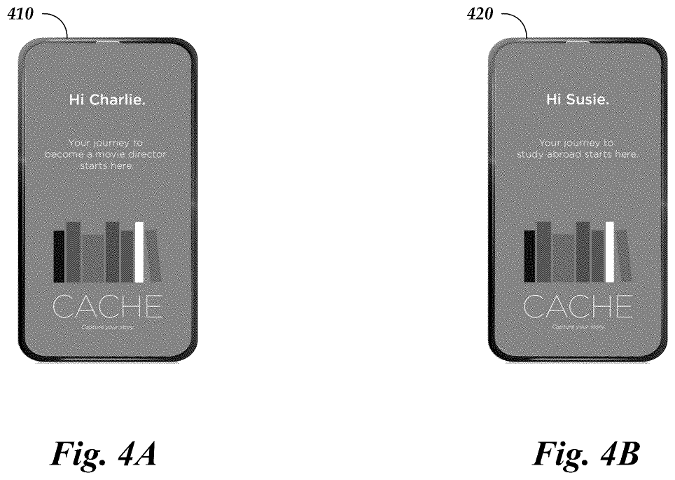

FIGS. 4A through 20 depict various user interfaces that may be displayed by a user device 102 in response to receiving user interface data generated and transmitted by the user interface generator 123.

FIGS. 4A-4B illustrate example user interfaces 410 and 420 of the mobile application that may be displayed to a user that has created an account and selected one or more goals. As illustrated in FIG. 4A, Charlie has opted to begin a journey to become a move director, which is indicated by the user interface 410. As illustrated in FIG. 4B, and Susie has opted to begin a journey to study abroad, which is indicated by the user interface 420.

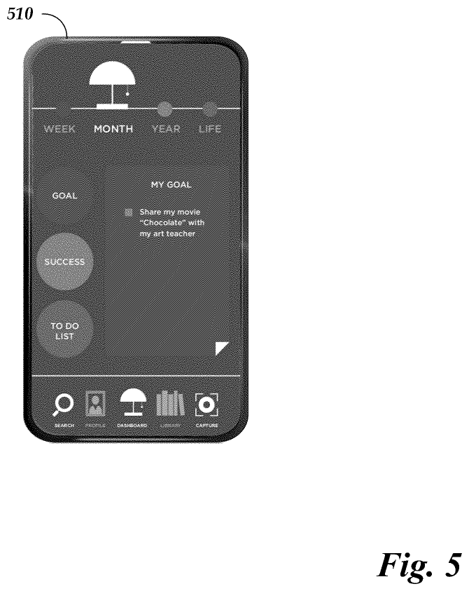

FIG. 5 illustrates an example user interface 510 of the mobile application showing a goal tab in a user's dashboard. As illustrated in FIG. 5, the user interface 510 includes a listing of goal(s) selected by Charlie. The dashboard may include a prompt to the user to remind the user to input accomplishments according to a particular time period (e.g., weekly, monthly, yearly, or as an overall career goal). The dashboard not only includes a goal tab, but also a success tab and a to do list tab for each are of the timeline. The goal, success, and/or to do list tab may prompt, notify, or otherwise alert a user when a deadline for completing a goal or completing a to do list task is approaching. The alert can be in the form of a push notification, an electronic message, a text message, etc.

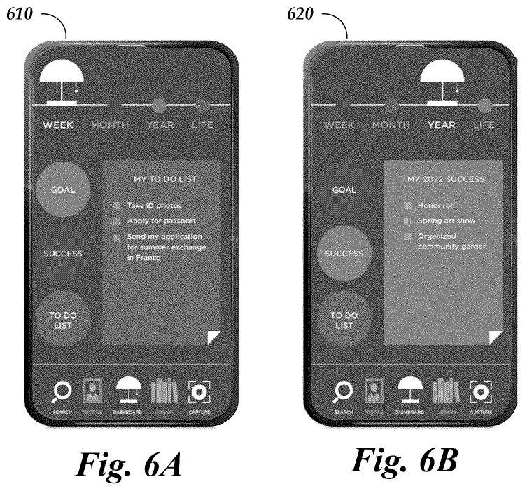

FIGS. 6A-6B illustrate example user interfaces 610 and 620 of the mobile application showing a to do list tab and a success tab in a user's dashboard. In the to do list tab depicted in the user interface 610 of FIG. 6A, the list of items may update automatically and/or periodically based on the journey selected by the user. In the success tab depicted in the user interface 620 of FIG. 6B, a list of goals and/or to do list items completed by the user may be listed.

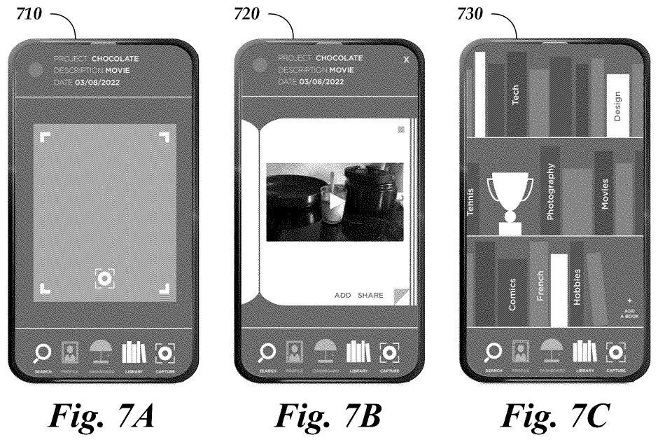

FIGS. 7A-7C illustrate example user interfaces 710, 720, and 730 of the mobile application showing a user library. As illustrated in FIG. 7A in the user interface 710, the user may be able to capture education and/or employment data using, for example, a camera of the user device. Once an image is captured, the image can be displayed in the mobile application, as shown in the user interface 720 of FIG. 7B. As shown in the user interface 730 of FIG. 7C, a user can view a summary of captured or inputted educational and/or employment data, organized by category (e.g., tech, design, sports, photography, movies, comics, foreign language, hobbies, etc.), where each category is represented in the form of a shape (e.g., the shape of a book, the shape of a trophy, the shape of a tilted book, and/or any other shape that may be present on a bookshelf) accompanied by text within the shape identifying the name of the category. Via the user interface 730, a user can select one of the shapes corresponding to a category, which causes the user interface 730 to display specific educational and/or employment data related to the category. In addition, via the user interface 730, a user can select an option to add a category (e.g., referred to as “add a book” in the user interface 730) to add a new category and corresponding shape to the bookshelf depicted in the user interface 730. Adding a new category may cause the mobile application to resize, recolor, reshape, move, and/or otherwise reconfigure none, some, or all of the existing shapes and/or resize, change the font of, rename (e.g., shorten a full length name of a category into an abbreviation of the category, such as from “Design” to “Des.,” replace a name of a category with a synonym with fewer letters, such as from “Movies” to “Films”, etc.), or otherwise reconfigure none, some, or all of the existing text within the existing shape(s) such that the new shape corresponding to the new category can fit within the finite screen space of the user interface 730 with text that is legible to a user of the user device (e.g., such that the text is readable when the user device is a typical distance from a user's eyes, such as 1 foot, 2 feet, 3 feet, etc. from a user's eyes).

FIGS. 8A-8B illustrate another example user interfaces 810 and 820 of the mobile application showing a user library. As illustrated in FIG. 8A in the user interface 810, a user selected the summer exchange category depicted in the user interface 820 of FIG. 8B. As a result, the user interface 820 transitioned from showing the graphical bookshelf to depicting a page of a book that provides a table of contents listing the education and/or employment data inputted in relation to this summer exchange category. Selecting the triangle icon near the bottom right of the user interface 810 that resembles the flipping of a page may cause the user interface 810 to depict another page of the book, which may include information for a portion of the education and/or employment data inputted in relation to this summer exchange category.

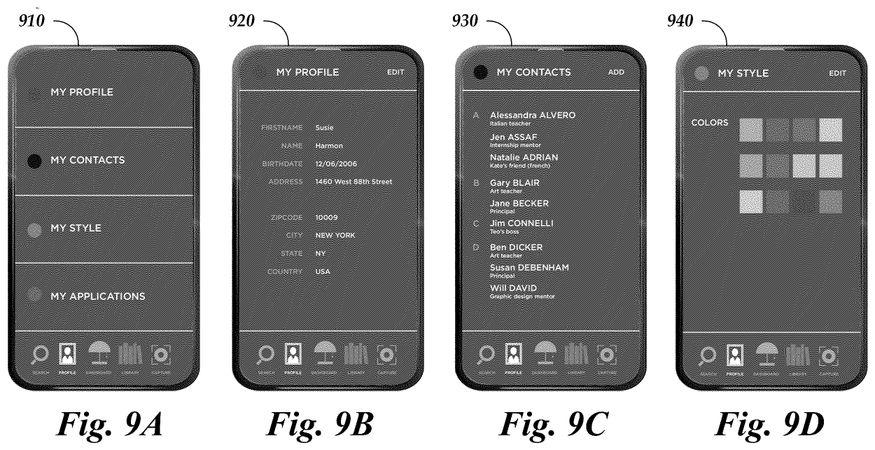

FIGS. 9A-9D illustrate example user interfaces 910, 920, 930, and 940 of the mobile application showing a user profile. As illustrated in FIG. 9A in the user interface 910, the user profile may include a profile section, a contacts section, a style section, and an applications section. In the profile section, the user can enter and/or view biographical information, like name, address, date of birth, etc., as depicted in the user interface 920 of FIG. 9B. In the contacts section, the user can input and/or view contact information for various community members, such as teachers, friends, school administrators, mentors, recommenders, coaches, employers, etc., as depicted in the user interface 930 of FIG. 9C. In the style section, the user can select one of various colors, which can be included in content shared with community members, as depicted in the user interface 940 of FIG. 9D.

While the present application is described as being directed to a mobile application and associated system that provides a centralized storage platform for users to motivate the users to capture, organize, and/or share the user's own achievements over time, this is not meant to be limiting. For example, any of the features of the mobile application described above can be implemented in a desktop application, browser-based application, or any other application that can be installed and run on a computing device.

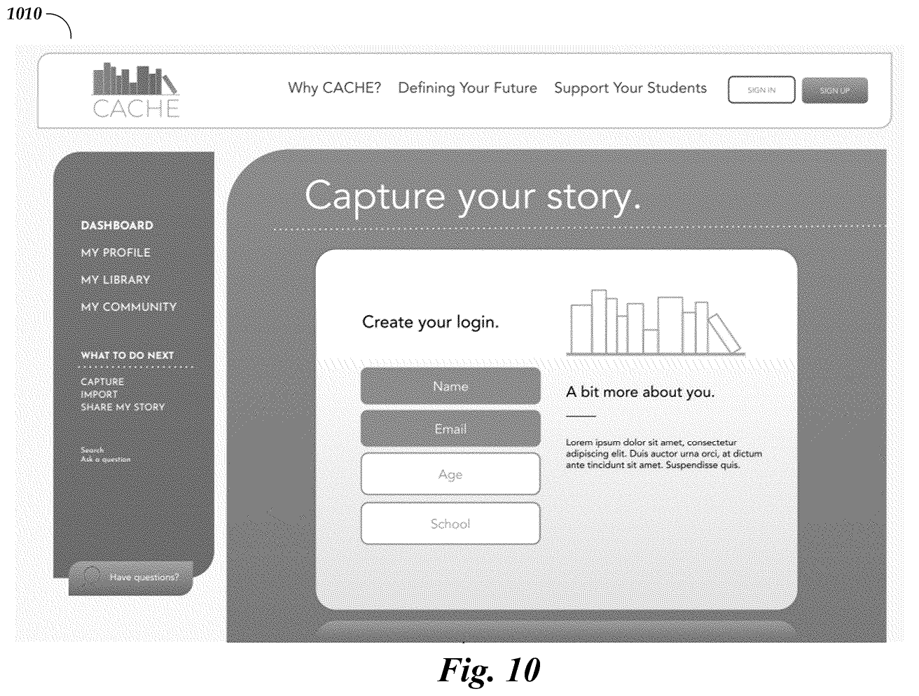

FIG. 10 illustrates an example user interface 1010 of a landing page of a desktop application. From the landing page, a user can login to view a dashboard page or a setup page.

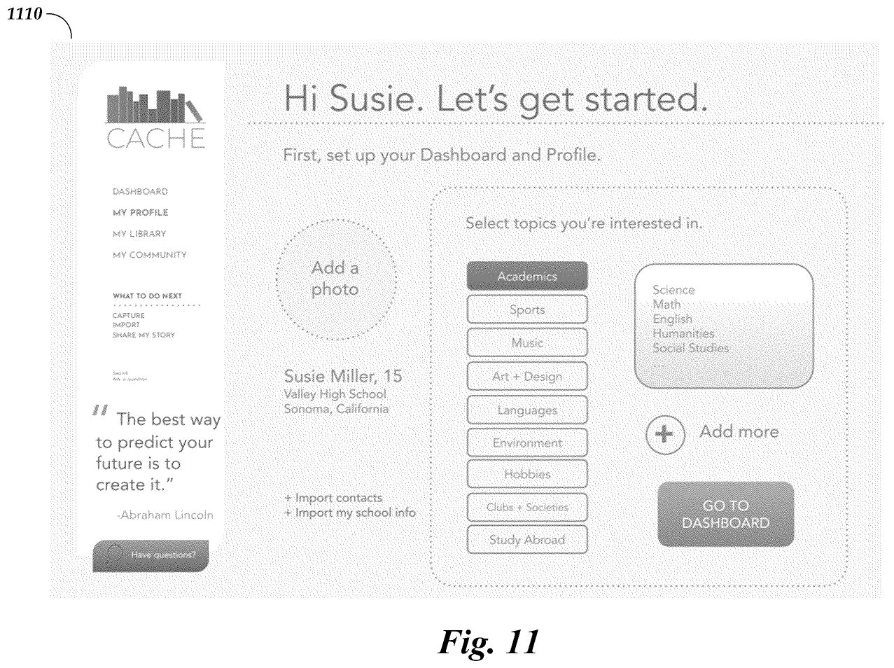

FIG. 11 illustrates an example user interface 1110 of a setup page of a desktop application. In the setup page, a user can add a photo, import contacts, import school information, select one or more topics of interest (e.g., academics, sports, music, art and design, languages, environment, hobbies, clubs and societies, study abroad, etc.), select one or more subtopics of interest (e.g., in academics, subtopics can include science, math, English, humanities, social studies, etc.; in sports, subtopics can include baseball, basketball, football, soccer, tennis, hocket, etc.; etc.), and/or go to the dashboard page.

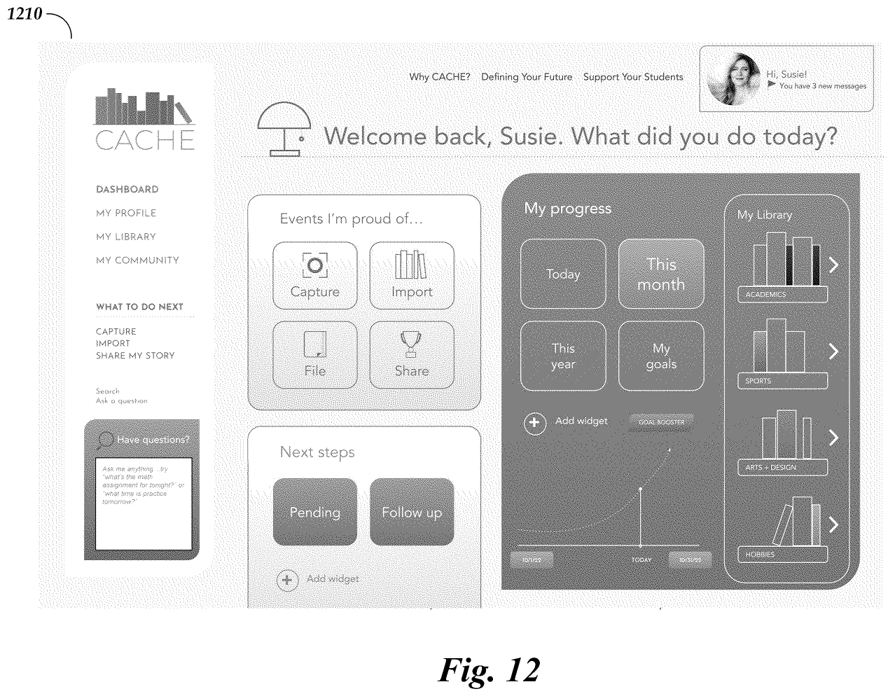

FIG. 12 illustrates an example user interface 1210 of a dashboard page of a desktop application. On the dashboard page, a user can capture, import, file, and/or share events; can view a library of stored events or accomplishments organized by category; view the user's goal(s); view the user's goal progress by time range (e.g., today, this month, this year, etc.) in graph form (e.g., line chart, pie chart, etc.); view the user's goal booster; and/or the like.

The goal booster may provide one or more suggestions to a user on accomplishments to record or pursue, events or activities to attend in the future, and/or any other types of suggestions that may assist the user in achieving a goal within a certain timeframe (e.g., by the time the user begins applying for college). The suggestions may be generated by the recommendation generator 121 in a manner as described herein. The goal for which the suggestions are provided may be a goal indicated by the user or a goal derived by the achievement aggregation system 120 based on events or accomplishments already captured by the user. For example, the achievement aggregation system 120 (e.g., the recommendation generator 121) can train a goal derivation artificial intelligence model (e.g., a machine learning model, a neural network, etc.) to predict a goal a user may be trying to achieve or can achieve given the accomplishments already recorded by the user. The achievement aggregation system 120 can train the goal derivation artificial intelligence model using training data, where each training data item includes a set of accomplishments recorded by a user labeled with an indication of a goal pursued by the user.

The achievement aggregation system 120 (e.g., the recommendation generator 121) can alternatively or in addition train a goal booster artificial intelligence model (e.g., a machine learning model, a neural network, etc.) to predict which accomplishment a user should receive, which event a user should attend, and/or the like. The achievement aggregation system 120 can train multiple goal booster artificial intelligence models, one for each type of goal, or can train a single goal booster artificial intelligence model. The achievement aggregation system 120 can train the goal booster artificial intelligence model using training data, where each training data item includes a set of accomplishments recorded by a user labeled with an indication of whether a particular goal was or was not achieved by the user. If the achievement aggregation system 120 is training a goal booster artificial intelligence model for a specific type of goal, then the training data may be limited to training data items corresponding to that specific type of goal.

If the user has not already indicated the goal to be pursued, the achievement aggregation system 120 can apply as an input to the trained goal derivation artificial intelligence model an indication of one or more accomplishments recorded by the user, which may cause the trained goal derivation artificial intelligence model to output an indication of a goal that the user may be trying to achieve or can achieve. The achievement aggregation system 120 can then apply as an input to the training goal booster artificial intelligence model an indication of the goal that the user has indicated he or she is pursuing or an indication of the predicted goal outputted by the goal derivation artificial intelligence model and an indication of one or more accomplishments recorded by the user, which may cause the trained goal booster artificial intelligence model to output an indication of a suggested event, activity, or accomplishment to pursue and/or record that will help the user achieve the goal. The achievement aggregation system 120 can display the suggestion when, for example, the user selects a goal booster button in the dashboard page or can display the suggestion directly on the dashboard page without any user input.

In an embodiment, any or all of the functionality of the dashboard of FIG. 5 and of the dashboard of FIG. 12 can be combined into a single dashboard page.

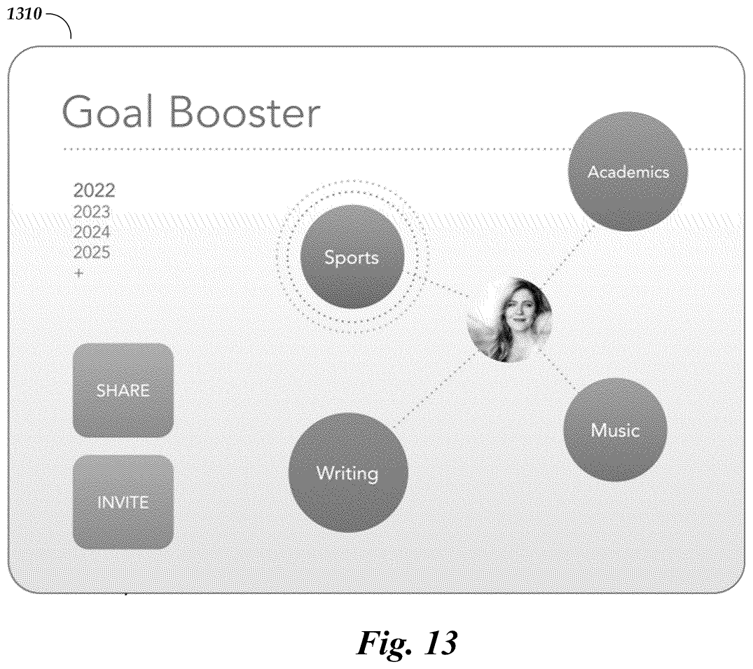

FIG. 13 illustrates an example user interface 1310 of a goal booster page of a desktop application that may be presented to the user when the user selects the goal booster button. The user may have multiple goals, and therefore the suggestion(s) may be organized by category and/or timeframe by which the suggested action should be taken. The user can share or invite others to view the goal booster suggestion(s).

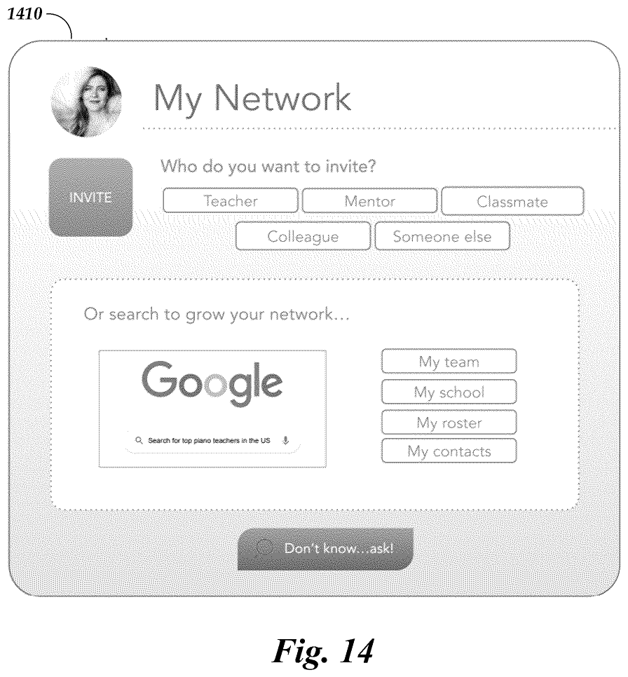

FIG. 14 illustrates an example user interface 1410 of an invitation page of a desktop application. The user can invite teachers, mentors, classmates, colleagues, and/or someone else to view any or all of the information stored in the user's profile or library. The user may have the ability to select which information can be viewed and/or not viewed by others.

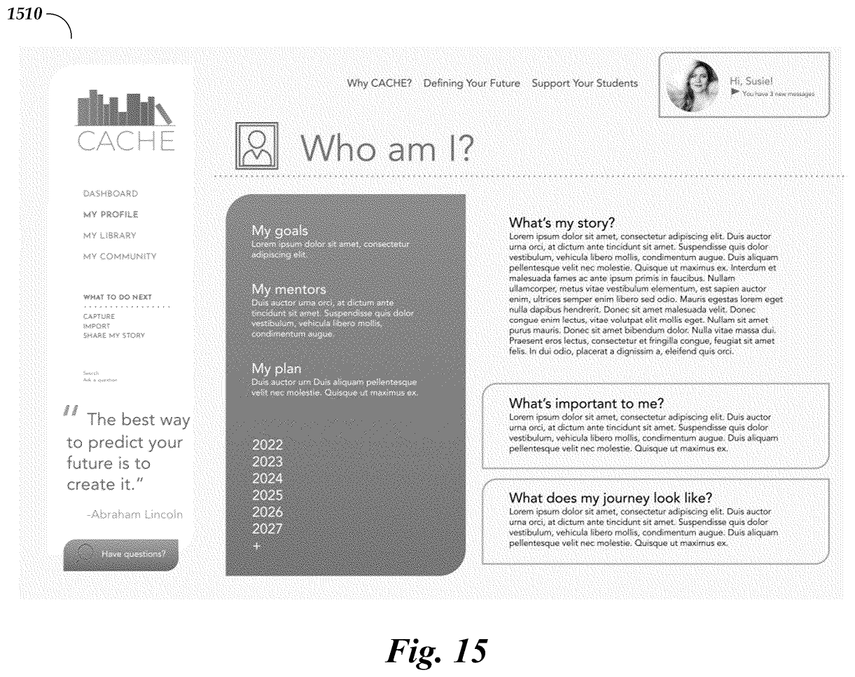

FIG. 15 illustrates an example user interface 1510 of a profile page of a desktop application. The profile page can include a list of the user's goals, mentors, plans, stories, etc.

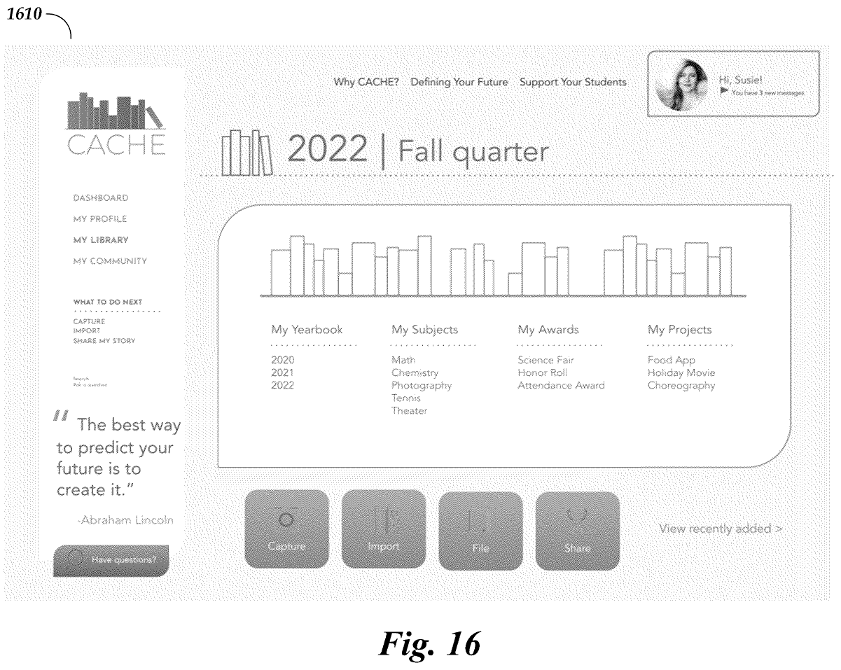

FIG. 16 illustrates an example user interface 1610 of a library page of a desktop application. In an embodiment, any or all of the functionality of the library of FIGS. 7A-7C, 8A-8B, and/or 16 can be combined into a single library page.

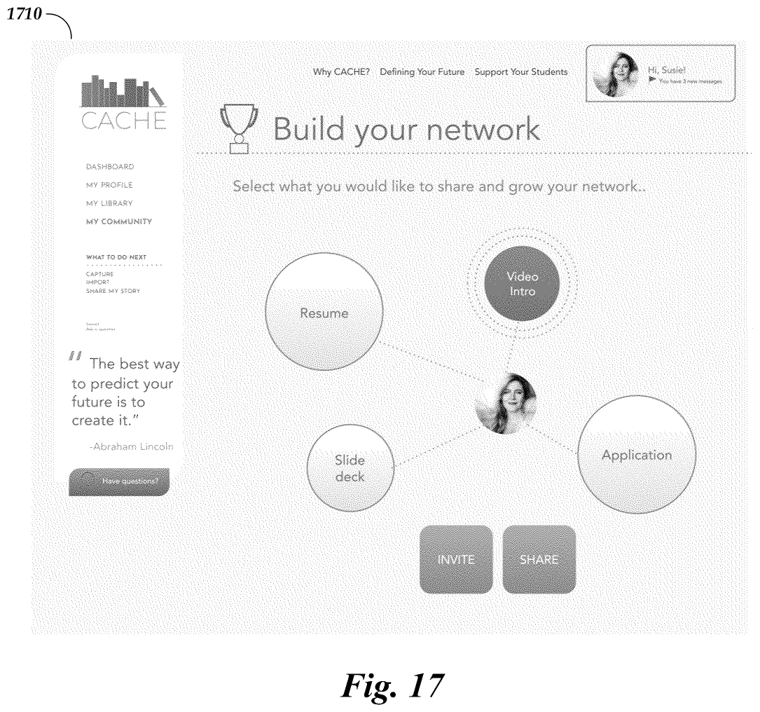

FIG. 17 illustrates an example user interface 1710 of a community page of a desktop application. The community page can include a video introduction viewable by others, a resume viewable by others, a slide deck viewable by others, and/or any other information or data that a user may like to share with others.

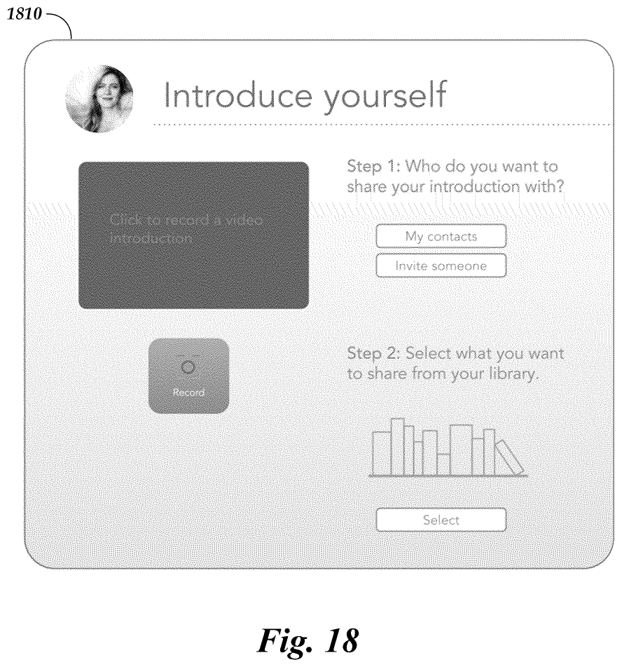

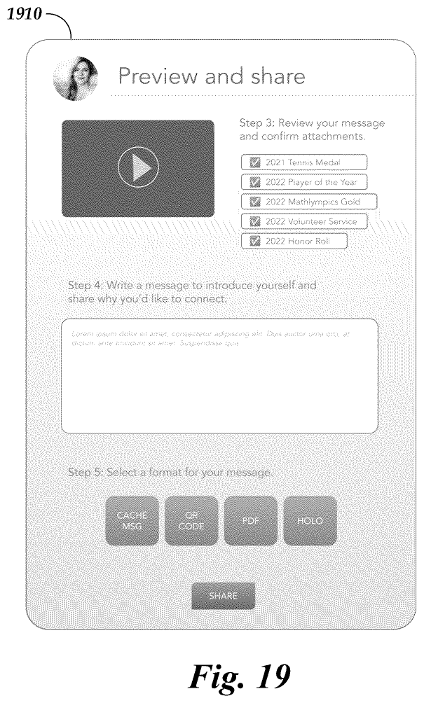

FIGS. 18-19 illustrates an example user interface 1810 and 1910, respectively, of a video introduction page of a desktop application. The video introduction page allows a user to record a video to introduce himself or herself and/or to share the video along with zero or more stored accomplishments with others. The user can also draft a written message that can be shared with the video and/or accomplishments. The video, accomplishments, and/or written message can be shared via a text message, a direct message via the desktop application, a QR code, a PDF, a hologram, and/or the like.

For example, in addition to or alternative to a video introduction, the achievement aggregation system 120 (e.g., the user interface generator 123) can create a holographic version of the user using one or more images of the user's face and/or body. The holographic version of the user can be a three-dimensional avatar that can be displayed to others in the user's network, where the three-dimensional avatar can move to speak or demonstrate any information that the user would like to share with her or her contacts (e.g., the video introduction, zero or more accomplishments, the written message, etc.).

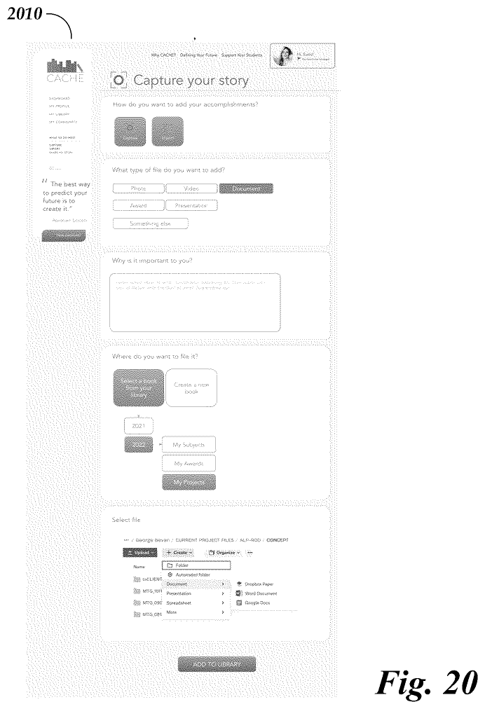

FIG. 20 illustrates an example user interface 2010 of an accomplishment add page of a desktop application that allows a user to record and store an accomplishment. The user can store various type of media, includes photos, videos, documents, presentations, awards, etc.

Any or all of the features described above with respect to FIGS. 10-20 can be implemented within the described mobile application as well.

### Example Property Information Retrieval Routines

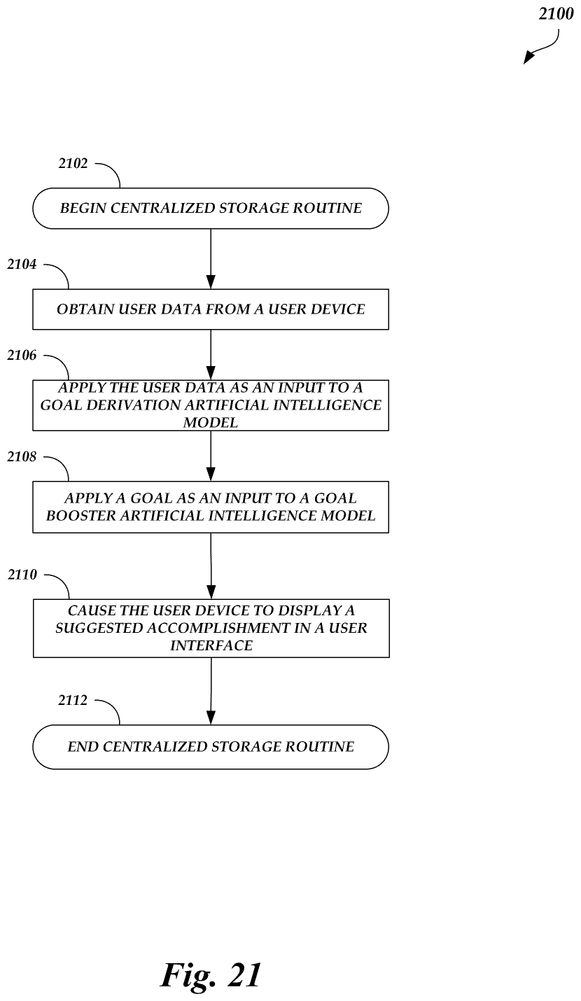

FIG. 21 is a flow diagram depicting an example, centralized storage routine 2100 illustratively implemented by an achievement aggregation system, according to one embodiment. As an example, the achievement aggregation system 120 of FIG. 1 can be configured to execute the centralized storage routine 2100. The centralized storage routine 2100 begins at block 2102.

At block 2104, user data is obtained from a user device. For example, the user data can include any education and/or employment data captured by the user device.

At block 2106, the user data is applied as an input to a goal derivation artificial intelligence model. Application of the user data as an input to the goal derivation artificial intelligence model may cause the goal derivation artificial intelligence model to output a suggested goal for the user.

At block 2108, a goal (such as the goal output by the goal derivation artificial intelligence model) is applied as an input to a goal booster artificial intelligence model. Application of the goal as an input to the goal booster artificial intelligence model may cause the goal booster artificial intelligence model to output an indication of a suggested accomplishment for the user to pursue to meet or achieve the goal.

At block 2110, the user device is caused to display the suggested accomplishment in a user interface. For example, the suggested accomplishment may be displayed on a dashboard page of a mobile or desktop application. The user device may receive user interface data from the achievement aggregation system 120 that, when processed by the user device, may cause the user device to display the suggested accomplishment. After the user device is caused to display the suggested accomplishment, the centralized storage routine 2100 ends, as shown at block 2112.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for centralizing storage of user data, the system comprising:
memory that stores computer-executable instructions; and
a processor in communication with the memory, wherein the computer-executable instructions, when executed by the processor, cause the processor to:
obtain education data from a user device;
apply the education data as an input to a goal derivation artificial intelligence model, wherein application of the education data as the input to the goal derivation artificial intelligence model causes the goal derivation artificial intelligence model to output a goal;
apply the goal as an input to a goal booster artificial intelligence model, wherein application of the goal as the input to the goal booster artificial intelligence model causes the goal booster artificial intelligence model to output an indication of a suggested accomplishment to pursue to achieve the goal; and
cause the user device to display the suggested accomplishment in a user interface in response to a user selection of a goal booster user interface element depicted in the user interface.

2. The system of claim 1, wherein the computer-executable instructions, when executed, further cause the processor to apply the goal and the education data as the input to the goal booster artificial intelligence model.

3. The system of claim 1, wherein the computer-executable instructions, when executed, further cause the processor to train the goal derivation artificial intelligence model using training data, wherein the training data comprises one or more training data items, and wherein an individual training data item comprises a set of accomplishments recorded by a second user and is labeled with an indication of a second goal pursued by the second user.

4. The system of claim 1, wherein the computer-executable instructions, when executed, further cause the processor to train the goal booster artificial intelligence model using training data, wherein the training data comprises one or more training data items, and wherein an individual training data item comprises a set of accomplishments recorded by a second user and is labeled with an indication of whether a second goal pursued by the second user was achieved by the second user.

5. The system of claim 1, wherein the goal derivation artificial intelligence model comprises one of a machine learning model or a neural network.

6. The system of claim 1, wherein the user interface comprises a second user interface element that allows a user of the user device to capture the education data.

7. The system of claim 1, wherein the user interface comprises a library of stored second education data organized by category.

8. The system of claim 1, wherein the user interface comprises an indication of a progress of a user in achieving the goal.

9. The system of claim 1, wherein the education data comprises at least one of an image of an academic award won or academic achievement earned by a user, an image of a trophies earned by the user, data representing an athletic performance or achievement by the user, a report card received by the user, a transcript received by the user, a test score earned by the user, a writing sample written by the user, an image of artwork created by the user, a resume, video of a performance by the user, or audio of a second performance by the user.

10. A computer-implemented method for centralizing storage of user data, the computer-implemented method comprising:
obtaining the user data from a user device;
applying the user data as an input to a goal derivation artificial intelligence model, wherein application of the user data as the input to the goal derivation artificial intelligence model causes the goal derivation artificial intelligence model to output a goal;
applying the goal as an input to a goal booster artificial intelligence model, wherein application of the goal as the input to the goal booster artificial intelligence model causes the goal booster artificial intelligence model to output an indication of a suggested accomplishment to pursue to achieve the goal; and
causing the user device to display the suggested accomplishment in a user interface in response to a user selection of a goal booster user interface element depicted in the user interface.

11. The computer-implemented of claim 10, wherein applying the goal as the input to the goal booster artificial intelligence model further comprises applying the goal and the user data as the input to the goal booster artificial intelligence model.

12. The computer-implemented of claim 10, further comprising training the goal derivation artificial intelligence model using training data, wherein the training data comprises one or more training data items, and wherein an individual training data item comprises a set of accomplishments recorded by a second user and is labeled with an indication of a second goal pursued by the second user.

13. The computer-implemented of claim 10, further comprising training the goal booster artificial intelligence model using training data, wherein the training data comprises one or more training data items, and wherein an individual training data item comprises a set of accomplishments recorded by a second user and is labeled with an indication of whether a second goal pursued by the second user was achieved by the second user.

14. The computer-implemented of claim 10, wherein the goal derivation artificial intelligence model comprises one of a machine learning model or a neural network.

15. The computer-implemented of claim 10, wherein the user interface comprises a second user interface element that allows a user of the user device to capture the education data.

16. The computer-implemented of claim 10, wherein the user interface comprises a library of stored second education data organized by category.

17. The computer-implemented of claim 10, wherein the user interface comprises an indication of a progress of a user in achieving the goal.

18. The computer-implemented of claim 10, wherein the user data comprises at least one of an image of an academic award won or academic achievement earned by a user, an image of a trophies earned by the user, data representing an athletic performance or achievement by the user, a report card received by the user, a transcript received by the user, a test score earned by the user, a writing sample written by the user, an image of artwork created by the user, a resume, video of a performance by the user, audio of a second performance by the user, an indication of a degree earned by the user, or proof of a skill learned by the user.

19. A non-transitory, computer-readable medium comprising computer-executable instructions for retrieving property information, wherein the computer-executable instructions, when executed by a computer system, cause the computer system to:
obtain the user data from a user device;
apply the user data as an input to a goal derivation artificial intelligence model, wherein application of the user data as the input to the goal derivation artificial intelligence model causes the goal derivation artificial intelligence model to output a goal;
apply the goal as an input to a goal booster artificial intelligence model, wherein application of the goal as the input to the goal booster artificial intelligence model causes the goal booster artificial intelligence model to output an indication of a suggested accomplishment to pursue to achieve the goal; and
cause the user device to display the suggested accomplishment in a user interface in response to a user selection of a goal booster user interface element depicted in the user interface.

20. The non-transitory, computer-readable medium of claim 19, wherein the computer-executable instructions, when executed, further cause the computer system to train the goal derivation artificial intelligence model using training data, wherein the training data comprises one or more training data items, and wherein an individual training data item comprises a set of accomplishments recorded by a second user and is labeled with an indication of a second goal pursued by the second user.
